(19) United States
(12) Patent Application Publication
(10) Pub. No.: US 2026/0033475 A1
(43) Pub. Date: Feb. 5, 2026

(54) QUICK CHANGE FISHING REEL SPOOL, METHODS OF USE, METHODS OF MAKING, AND ASSOICATE DEVICES AND SYSTEMS

(71) Applicant: Tridec Services Inc., Raleigh, NC (US)

(72) Inventors: Larry J. Markoski, Raleigh, NC (US); Kurt A. Kulberg, Hillsborough, NC (US); Sean M. Ahr, Raleigh, NC (US)

(21) Appl. No.: 18/794,747

(22) Filed: Aug. 5, 2024

(51) Int. Cl. A01K 89/01

(52) U.S. Cl. CPC A01K 89/0111

(57) ABSTRACT

A quick-change spool, includes an exterior, including (i) a spool flange, at a top end of the quick-change spool, (ii) a spool skirt, at a bottom end of the quick-change spool, and (iii) a spool cylinder, between the spool flange and the spool skirt, an interior, including (iv) at least one spool alignment key, on a spool cylinder interior surface, (v) at least one spool torque transfer key, on a spool skirt interior surface, and (vi) at least one spool retention detent, on the spool skirt interior surface. Further, a quick-change spool system, comprises the quick-change spool, and a drag arbor. The quick-change spool and the drag arbor are configured to (a) releasably attached together, through interaction between a spool retention detent and a spool retention recess, and (b) transfer torque between each other when attached together, through interaction between a spool torque transfer key and a spool torque transfer slot.

### BACKGROUND

Spinning reels are a very popular type of reel used in sport fishing. FIG. 1 illustrates a spinning reel with a front drag control, and FIG. 2 is an expanded view of the spinning reel. The spinning reel, 10, includes a drag knob assembly, 12, which is attached to a reel body assembly, 16, which retains a spool assembly, 14, between the drag knob assembly and the reel body assembly, along a semi-square shaft of the reel body assembly. The shaft engages the spool assembly with the reel body assembly. The drag knob assembly also engages with the spool assembly. Typically, the drag knob assembly screws onto a threaded portion of the semi-square shaft of the reel body assembly. Also illustrated are a fishing rod attachment base (or shoe), 18, which is attached to the reel body assembly, and a fishing rod, 20, which is attached to the fishing rod attachment base.

FIG. 3 illustrates the drag knob assembly, 12, and FIG. 4 is an expanded view of the drag knob assembly. The drag knob assembly includes a drag knob, 22, and a drag knob assembly mechanism, 24, attached to the drag knob. FIG. 5 illustrates the spool assembly, 14, and FIG. 6 is an expanded view of the spool assembly. The spool assembly includes a conventional spool, 28, and a drag disc assembly mechanism, 26, attached to the conventional spool.

When in use, a length of fishing line is attached to and wound around the conventional spool, then threaded through the eyelets attached along the fishing rod. At the end of the fishing line is attached a lure, hook or series of hooks, and/or bait with optional additional weights to aid in casting or sinking the line (lure). During sport fishing with a spinning reel, a user must flip a bail arm (shown in FIG. 23, and which is a part of the reel body assembly) to a casting position which disengages the line from the bail, and then cast the lure, whose momentum pulls the fishing line from the stationary spool. The user then flips the bail arm down to re-engage the line, preventing the fishing line from unwinding further from the spool until a force on the fishing line in excess of a selected value and enables the line to be retrieved. The drag knob may be used to adjust the force needed to unwind the fishing line while the bail arm is in the down position (drag engaged). After casting or once a fish is on the hook, a user turns a handle of the reel body assembly, which rotates the bail arm around the spool, winding the fishing line back onto the spool, in order to reel in the fish or retrieve the lure. Typically, a user will wind in the line, and may allow the fish to pull against the drag to unwind the line, repeatedly, in order to exhaust the fish and pull the fish through and out of the water, without the drag break force exceeding the strength or breaking force of the fishing line.

The entire spinning reel is typically sold assembled, and then fixed firmly to the fishing rod, without fishing line. A user will then separately purchase fishing line and wind the fishing line onto the conventional spool prior to use. Several different types of fishing line are available, each having different breaking strengths and/or other characteristics, intended for different types of fishing and/or for catching different types of fish. Different types of fishing line may have different compositions, different cross-section diameters, and although most have a circular cross section, others have non-circular cross sections (see, for example, “Welcome to Mel's 2019 Fishing Line Diameter page” (2019), available at www.melsplace.com/String/string.htm). Winding fishing line onto the conventional spool so that it does not twist and tangle during use, and to achieve optimum performance of various specialized fishing lines, requires skill and experience (see, for example: Reynolds, M., et al. “How to Spool a Spinning Reel” wikiHow (Sep. 15, 2015) available at www.wikihow.com/Spool-a-Spinning-Reel; Robins, P. “How to Spool a Spinning Reel” Outdoor Life (May 22, 2023) available at www.outdoorlife.com/gear/how-to-spool-a-spinning-reel/; and Hanson, D. “How to Spool a Spinning Reel with Braided Line” Recreational Boating & Fishing Foundation (Feb. 2, 2022) available at www.takemefishing.org/blog/february-2022/how-to-spool-a-spinning-reel-with-braided-line/).

It is well known that the outer end of the fishing line on the spool should be located at about 1/16th to 1/8th of an inch (1.6 to 3.2 mm) away from the outside edge of the rim of the spool, to provide optimum casting of the fishing line (often referred to as the “sweet spot”). Because the conventional spool is sized for a broad range of uses, with a broad range of fishing line types, much of the fishing line present on the conventional spool will never be used, if the outer edge of the fishing line on the spool is located in the sweet spot. Furthermore, some high-performance fishing lines, such as copolymer lines containing fluorocarbons and braided lines (as opposed to typical nylon-based monofilament lines) are comparatively expensive. Therefore, it is often the case that an inexpensive fishing line, such as nylon-based monofilament line, is first attached to the conventional spool as a backing line, and then the more expensive high-performance line is tied, or otherwise attached, to the inexpensive fishing line (referred to as backing line) to reduce the total cost of the line present on the spool but still achieve the benefits of using the high-performance fishing line (ld.). The complexity and time required to prepare a spinning reel with fishing line for the needs of the user during a single fishing trip leads most experienced users to prepare multiple spinning reels in advance, each with a different type of fishing line, and transport several sets of spinning reels to the fishing site.

Changeable spools, which allow a user to prepare spools with various fishing lines in advance, are known in the art. The use of changeable spools thus avoids the need to transport several sets of spinning reels to the fishing site. For example, U.S. Pat. No. 9,480,246 describes a detachable line cartridge system, which includes a line cartridge for holding fishing line, having a cylinder for holding fishing line flanked by wide flanges, which may be exchanged on a spinning reel. A base, for holding the line cartridge include spring loaded ball bearings to assist in retaining the line cartridge onto the base, as well as a flange assembly which is placed on top of the line cartridge and which includes springs for holding the line cartridge onto the base. The system uses a conventional drag knob, and the drag knob must be removed and reattached in order to exchange the line cartridges.

Another example, U.S. Pat. Pub. No. 2009/0250542 describes a pre-wound spinning reel spool replacement apparatus, which includes a line holding spool having a cylinder for holding fishing line flanked by wide flanges, which is held onto a mounting spool. The mounting spool is made to slip onto the arbor of an existing spinning reel, and a retainer cap is used to hold the line holding spool onto the mounting spool. These three pieces appear to replace the spool of a typical spinning reel, and disassembly and reassembly of the spinning reel normally required to switch spools appears to be required to exchange the line holding spool, including removal and reattachment of the drag knob. U.S. Pat. No. 5,120,003 describes a similar system.

Another example, U.S. Pat. No. 6,712,300 describes a quick-change spool system, which include a variation intended for a top drag spindle assembly. The top drag spool base assembly holds a spool having a cylinder flanked by a bottom flange, a top flange and includes a curved top surface which fits over a spool release button which also serves as a drag adjust knob. The spool release button is part of the spool base assembly, which also includes a spring clip formed from hardened steel for retaining the spool, a hub for engaging the spool, and screws for holding the assembly together.

Another example, U.S. Pat. No. 3,693,901 describes a quick-change cartridge spool. The system includes a spool for holding fishing line, having a cylinder for holding fishing line, flanked by wide flanges. The spool is held by an adaptor, which engages the spool by a protruding lug on the adaptor and a corresponding port in one flange of the spool and prevent relative rotation between the spool and arbor. Rotation is also prevented by additional lugs which engage the interior of the spool core.

### SUMMARY

In a first aspect, the invention is a quick-change spool, comprising an exterior, including (i) a spool flange, at a top end of the quick-change spool, (ii) a spool skirt, at a bottom end of the quick-change spool, and (iii) a spool cylinder, between the spool flange and the spool skirt, an interior, including (iv) at least one spool alignment key, on a spool cylinder interior surface, (v) at least one spool torque transfer key, on a spool skirt interior surface, and (vi) at least one spool retention detent, on the spool skirt interior surface.

In a second aspect, the invention is a quick-change spool system, comprising a quick-change spool, and a drag arbor. The quick-change spool and the drag arbor are configured to (a) releasably attached together, through interaction between a spool retention detent and a spool retention recess, and (b) transfer torque between each other when attached together, through interaction between a spool torque transfer key and a spool torque transfer slot. The quick-change spool comprises (i) a spool flange, at a top end of the quick-change spool, (ii) a spool skirt, at a bottom end of the quick-change spool, and (iii) a spool cylinder, between the spool flange and the spool skirt.

In a third aspect, the invention is a quick-change spool system, comprising a quick-change spool, and a drag arbor. The quick-change spool and the drag arbor comprise (a) means for releasably attaching together, and (b) means for transferring torque between each other when attached together. The quick-change spool comprises (i) a spool flange, at a top end of the quick-change spool, (ii) a spool skirt, at a bottom end of the quick-change spool, and (iii) a spool cylinder, between the spool flange and the spool skirt.

In a fourth aspect, the invention is a quick-change spool, comprising (i) a spool flange, at a top end of the quick-change spool, (ii) a spool skirt, at a bottom end of the quick-change spool, and (iii) a spool cylinder, between the spool flange and the spool skirt. The quick-change spool is monolithic and consists of plastic.

In a fifth aspect, the invention is a set of ready-to-use quick-change spools, comprising a package, and a plurality of ready-to-use quick-change spools, contained in the package.

In a sixth aspect, the invention is a drag arbor, comprising (1) a bottom end having a first circumference, (2) a top end having a second circumference, (3) a spool retention recess, on the bottom end, and (4) a spool torque transfer slot, on the top end. The first circumference is large enough to fit around the second circumference.

In a seventh aspect, the invention is a method of making the quick-change spool, comprising injection molding or forming with additive manufacturing. The quick-change spool is monolithic and consists of plastic.

In an eighth aspect, the invention is a method of making the drag arbor, comprising injection molding or forming with additive manufacturing. The drag arbor is monolithic and consists of plastic.

In a ninth aspect, the invention is a method of using the quick-change spool system, comprising exchanging the quick-change spool for a different quick-change spool.

In a tenth aspect, the invention is a spinning reel having (I) a drag knob assembly with a drag knob and drag knob assembly mechanism, (II) a spool assembly with a conventional spool and a drag disc assembly mechanism, (III) a reel body assembly with bail arm and a drag engagement mechanism, and (IV) a fishing rod attachment base, the improvement comprising substituting the conventional spool for a quick-change spool and a drag arbor, the quick-change spool, comprising (i) a spool flange, at a top end of the quick-change spool, (ii) a spool skirt, at a bottom end of the quick-change spool, and (iii) a spool cylinder, between the spool flange and the spool skirt. The drag knob and the quick-change spool are sized to allow the drag knob to pass through an interior of the spool cylinder, and the quick-change spool and the drag arbor are configured to (a) releasably attached together, through interaction between a spool retention detent and a spool retention recess, and (b) transfer torque between each other when attached together, through interaction between a spool torque transfer key and a spool torque transfer slot.

### BRIEF DESCRIPTION OF THE DRAWINGS

FIG. 1 illustrates a spinning reel with front drag control.

FIG. 2 is an expanded view of a spinning reel with front drag control.

FIG. 3 illustrates a drag knob assembly.

FIG. 4 is an expanded view of a drag knob assembly.

FIG. 5 illustrates a spool assembly.

FIG. 6 is an expanded view of a spool assembly.

FIG. 7 illustrates a spinning reel with front drag control including a quick-change fishing reel spool and a modified drag knob.

FIG. 8 is an expanded view of the spinning reel with front drag control shown in FIG. 7.

FIG. 9 illustrates the modified drag knob assembly.

FIG. 10 is an expanded view of the modified drag knob assembly of FIG. 9.

FIG. 11 illustrates a quick-change spool.

FIG. 12 shows the quick-change spool, together with an expanded view of a drag arbor assembly.

FIG. 13 illustrates a drag arbor.

FIG. 14 is a perspective views of the interior of a quick-change spool.

FIG. 15 is another view of the interior of the quick-change spool.

FIG. 16 illustrates a quick-change spool including a T-slot in the spool cylinder.

FIG. 17 illustrates a quick-change spool including a first hole and an optional second hole, in the spool cylinder.

FIG. 18 illustrates a quick-change spool with fishing line attached to the spool cylinder with tape.

FIG. 19 illustrates a quick-change spool having a label on the spool skirt.

FIG. 20 illustrates a quick-change spool with various dimensions labelled.

FIG. 21 illustrates multiple quick-change spools, each with fishing line, in a single package.

FIG. 22 illustrates the interior of the drag arbor.

FIG. 23 illustrates a view of the reel body assembly which engages with the drag arbor.

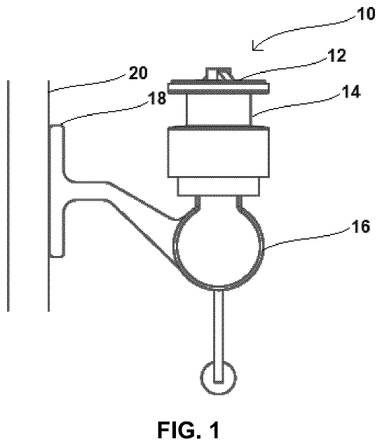

### DETAILED DESCRIPTION

Although prior changeable spool systems provided some possibility for experienced users to avoid the need to transport several sets of spinning reels to the fishing site, they have several disadvantages. Some systems require a user to disassemble the spinning reel, by removing the drag knob assembly, to change fishing line present on a cartridge or spool, and then reattach the drag knob assembly, all at the fishing site. Other changeable spool systems, although allowing for a quick change of the cartridge or spool at the fishing site, substitute the conventional spool assembly with several components, each separate and made from different materials, including steel, complicating use, installation and manufacture. Furthermore, none of the changeable spool systems use a spool or cartridge which has exposed surfaces during use, which would provide a suitable surface to provide information about the line contained on the spool or cartridge. None of these systems appear to have been widely commercialized.

The present invention provides for a quick-change fishing reel spool and system. The system includes only 3 parts which need to be substituted into an existing top drag spinning reel: a modified drag knob, sized to allow the drag knob to fit through the center of a spool cylinder of a quick-change spool; a quick-change spool for holding fishing line, which optionally may be a single injection molded piece or formed by additive manufacture, and preferably being monolithic, and which includes a skirt sized and situated for displaying information about the fishing line thereon; and a drag arbor for holding the quick-change spool and engaging it with the reel body assembly, which optionally may be a single injection molded piece or formed by additive or subtractive manufacture, and preferably being monolithic. The quick-change spool together with the drag arbor, replace the conventional spool used in a conventional top drag spinning reel.

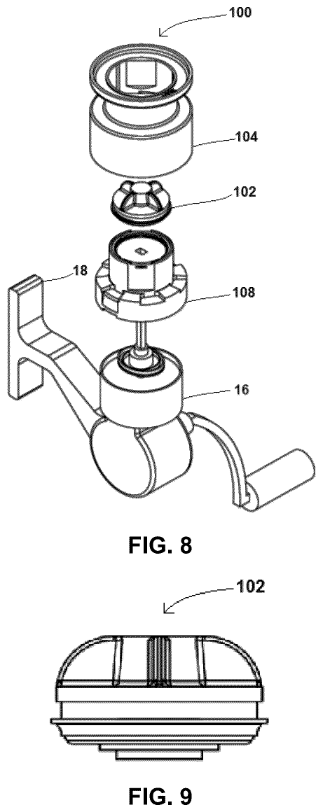

FIG. 7 illustrates a spinning reel with front drag control including the quick-change fishing reel spool (or simply “quick-change spool”, or “spool”), and the modified drag knob (or simply “drag knob”) of the present application, and FIG. 8 is an expanded view of the spinning reel with front drag control. The spinning reel, 100, includes a drag knob assembly, 102, which is attached to a reel body assembly, 16, which retains a drag arbor assembly, 108, between the drag knob assembly and the reel body assembly. The drag knob assembly screws onto a portion of the reel body assembly. A quick-change spool fits over the drag knob assembly, and attaches to the drag arbor assembly. The quick-change spool may be attached and removed from the drag arbor assembly by hand, without the need for any tools. Preferably, the quick-change spool may be attached by snapping it into place, and removed by pulling it off. Also illustrated are a fishing rod attachment base, 18, which is attached to the reel body assembly, and a fishing rod, 20, which is attached to the fishing rod attachment base.

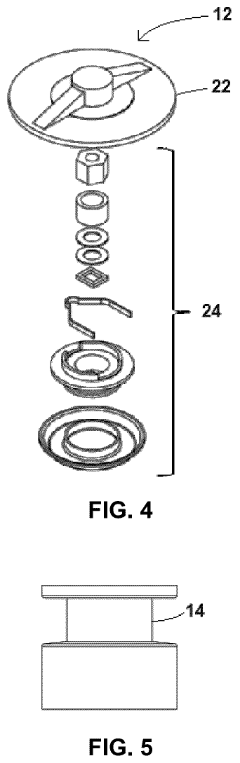

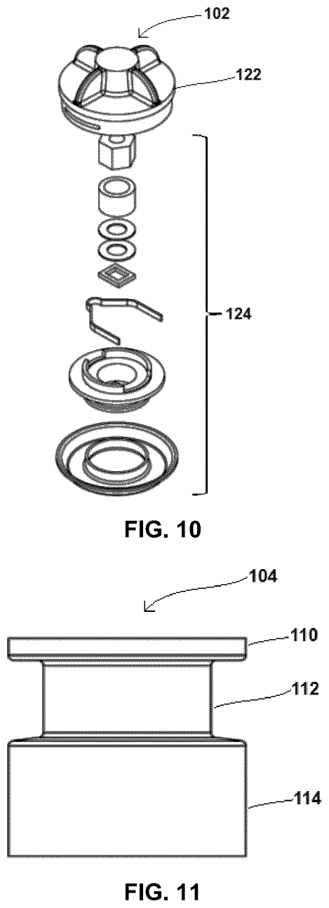

FIG. 9 illustrates a modified drag knob assembly, 102, and FIG. 10 is an expanded view of the modified drag knob assembly, including a modified drag knob, 122. The drag knob assembly includes a drag knob, 122, and a drag knob assembly mechanism, 124, attached to the drag knob. The drag knob assembly mechanism may be the same as the drag knob assembly used with typical spinning reels, such as that shown in FIG. 4. The drag knob is sized so that it can pass through the channel present in the center of a quick-change spool.

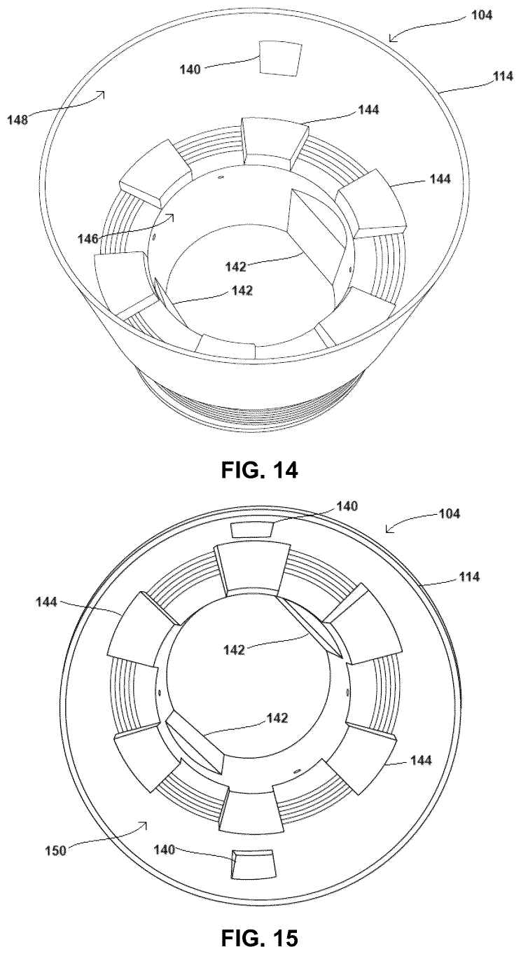

FIG. 11 illustrates the quick-change spool, 104. The spool includes a spool flange, 110, a spool cylinder, 112, and a spool skirt, 114. FIG. 14 and FIG. 15 are two different views of the interior of the quick-change spool. The spool includes a spool interior surface, 150, which includes a spool cylinder interior surface, 146, and a spool skirt interior surface, 148. As illustrated, the spool cylinder interior surface includes 2 spool alignment keys, 142 and 142, for aligning the spool in the correct orientation onto the drag arbor assembly. As illustrated, the spool skirt interior surface includes 6 spool torque transfer keys, 144 (with only 2 labelled in FIG. 14 and only 1 labelled in FIGS. 15), and 2 spool retention detents, 140 and 140 (with only 1 visible in FIG. 14).

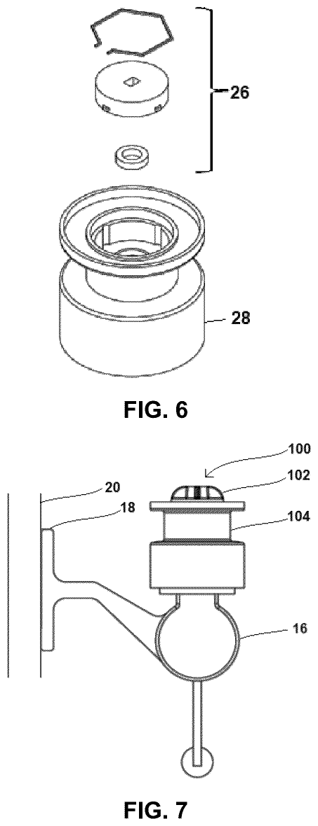

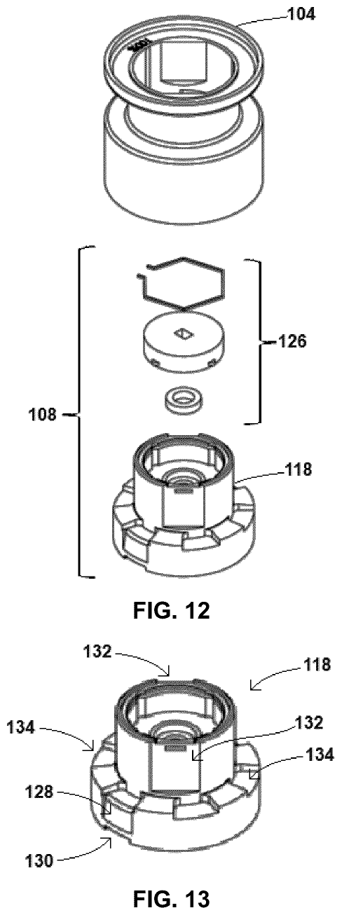

FIG. 12 shows the quick-change spool, 104, together with an expanded view of the drag arbor assembly, 108. The drag arbor assembly includes a drag arbor, 118, and a drag disc assembly mechanism, 126. The drag disc assembly mechanism may be the same as the drag disc assembly mechanism used with typical spinning reels, such as that shown in FIG. 6. The quick-change spool is configured to attach to the drag arbor, and a drag arbor is configured to retain the drag disc assembly mechanism when the quick-change spool is attached and removed.

FIG. 13 illustrates a drag arbor. The drag arbor, 118, as illustrated includes 2 spool alignment key channels, 132 and 132, which cooperate with the spool alignment keys to align the spool in the correct orientation on the drag arbor. As illustrated, the drag arbor assembly also includes 6 spool torque transfer slots, 134 and 134 (with only 2 labelled in the figure). Lastly, as illustrated, the drag arbor assembly includes 2 spool detent channels, 128 (with only one visible in the figure, the other on the opposite side), and just beyond the spool detent channels, 2 spool retention recesses, 130 (with only one visible in the figure, the other on the opposite side).

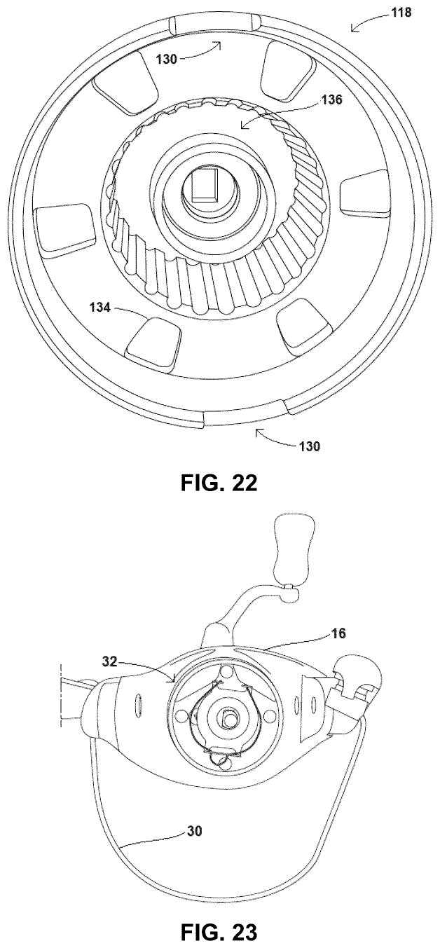

FIG. 22 illustrates the interior of the drag arbor, and FIG. 23 illustrates a view of the reel body assembly which engages with the drag arbor. The interior of the drag arbor, 118, includes a reel body engagement cavity, 136, which fits onto the reel body assembly, 16, and is configured to engage with the drag engagement mechanism, 32, of the reel body assembly. Also illustrated is the bail arm, 30 (which is part of the reel body assembly), the spool retention recesses, 130 and 130, as well as the underside of the spool torque transfer slots, 134 (with only 2 of 6 labelled).

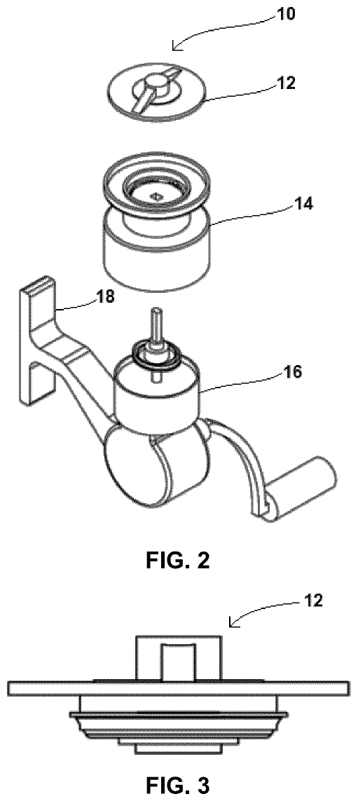

The quick-change spool, together with the drag arbor assembly, carries out the same functions during use as the spool assembly shown in FIG. 2, FIG. 5 and FIG. 6, as found in commercially available spinning reels with front drag controls. However, the traditional spool assembly has been split into 2 parts, the quick-change spool and the drag arbor assembly (which itself includes the drag arbor and the drag disc assembly mechanism). The quick-change spool and the drag arbor assembly are configured to attach together, and using complimentary structures for alignment, torque transfer, and retention, of and between the quick-change spool the drag arbor assembly, allows for swapping one quick change-spool for another by the user without unscrewing the drag knob or removing the spinning reel from the fishing pole.

Alignment of the quick-change spool on the drag arbor assembly (and the drag arbor) is accomplished by mating of one or more spool alignment keys and corresponding spool alignment key channels. These structures provide means for aligning the quick-change spool on the drag arbor assembly. Although illustrated with 2 opposing spool alignment keys and 2 opposing spool alignment key channels, 1, 2, 3, 4, 5, 6 or even more corresponding spool alignment keys and spool alignment key channels are possible. Furthermore, although illustrated with the spool alignment keys and spool alignment key channels distributed symmetrically about the interior of the quick-change spool and the drag arbor, respectively, the distribution could be asymmetrical, so long as the corresponding structures will mate. In addition, although illustrated with the width of the spool alignment keys all the same, they may be different; similarly, although illustrated with the width of the spool alignment key channels are all the same, they may be different, so long as the corresponding structures will mate. Lastly, the spool alignment keys could be present on the drag arbor, and spool alignment key channels could be present on the interior of the quick-change spool, so long as the corresponding structures will mate.

Torque transfer between the quick-change spool and the drag arbor assembly (and the drag arbor) is accomplished by mating of one or more spool torque transfer keys and corresponding spool torque transfer slots. These structures provide means for transferring torque between the quick-change spool and the drag arbor assembly (and the drag arbor). Although illustrated with 6 symmetrically distributed spool torque transfer keys and corresponding spool torque transfer slots, 1, 2, 3, 4, 5, 6, 7, 8 or even more spool torque transfer keys and corresponding spool torque transfer slots are possible. Furthermore, although illustrated with the spool torque transfer keys and spool torque transfer slots distributed symmetrically about the interior of the quick-change spool and the drag arbor, respectively, the distribution could be asymmetrical, so long as the corresponding structures will mate. In addition, although illustrated with the width, depth and/or length of the spool torque transfer keys all the same, they may be different; similarly, although illustrated with the width, depth and/or length of the spool torque transfer slots all the same, they may be different, so long as the corresponding structures will mate. Lastly, the spool torque transfer keys could be present on the drag arbor, and spool torque transfer slots could be present on the interior of the quick-change spool, so long as the corresponding structures will mate.

Attachment (or retention) between the quick-change spool and the drag arbor assembly (and the drag arbor) is accomplished by mating of one or more spool retention detents and corresponding spool retention recesses. These structures provide means for attaching (or retaining) the quick-change spool and the drag arbor assembly (and the drag arbor) together. Although illustrated with 2 opposing spool retention detents and 2 opposing spool retention recesses, 1, 2, 3, 4, 5, 6 or even more corresponding spool retention detents and spool retention recesses are possible. Furthermore, although illustrated with the spool retention detents and spool retention recesses distributed symmetrically about the interior of the quick-change spool and the drag arbor, respectively, the distribution could be asymmetrical, so long as the corresponding structures will mate. In addition, although illustrated with the width of the spool retention detents all the same, they may be different; similarly, although illustrated with the width of the spool retention recesses are all the same, they may be different, so long as these structures will mate. Furthermore, although the spool retention recesses are illustrated as recesses in the bottom surface of the drag arbor, they could instead be recesses farther up away from the bottom end of the drag arbor. Lastly, the spool retention detents could be present on the drag arbor, and spool retention recesses could be present on the interior of the quick-change spool, so long as these structures will mate.

Each spool retention recess has an optional corresponding spool detent channel. The spool retention recess allows the spool retention detent to more easily slide along the surface of the drag arbor. The softer or more elastic the material from which the quick-change spool and/or the drag arbor is formed, the more easily the spool retention detent will slide along the surface. A ridge may optionally be present between the spool retention recess and the corresponding spool detent channel, in order to further increase the force needed to remove the quick-change spool from the drag arbor.

The drag knob is preferably sized so that it can pass through the spool cylinder. Similarly, the spool cylinder contains a passage of sufficient diameter so that the drag knob can pass through.

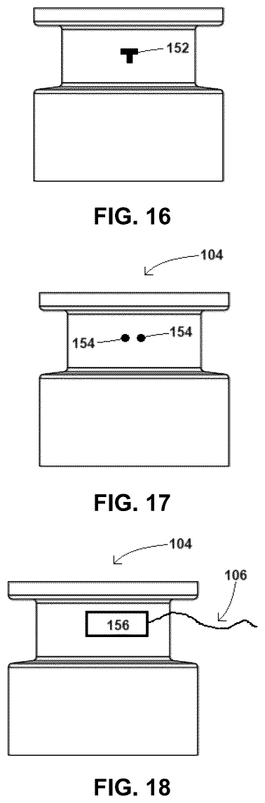

The spool cylinder of the quick-change spool holds fishing line. The non-working end of the fishing line may be attached or affixed to the quick-change spool in a variety of ways, including by the same techniques and structures as used with conventional spools. FIG. 16 illustrates a quick-change spool, 104, including a T-slot, 152, in the spool cylinder. Fishing line having a bead, knot or other solid piece at the non-working end may be threaded through the T-slot, and then shifted toward one arm of the T-slot, to affix the fishing line to the quick-change spool. FIG. 17 illustrates a quick-change spool, 104, including a first hole, 154, and an optional second hole, 154, both in the spool cylinder. Fishing line may be threaded through the first hole, and then knotted, or attached to a bead or other structure larger than the first hole, to affix the fishing line to the quick-change spool. When 2 holes are present, the fishing line may be threaded into the first hole, and back out through the second hole, followed by tying the non-working end to the remaining fishing line, for example, using an arbor knot, to affix the fishing line to the quick-change spool. FIG. 18 illustrates a quick-change spool, 104, with fishing line, 106, attached to the spool cylinder with tape, 156. The tape may be used alone to attach the fishing line to the spool cylinder of the quick-change spool, or the tape may be used together with techniques described above using the quick-change spools shown in FIG. 16 and FIG. 17 (with either one or two holes). Even without a T-slot, holes, and/or tape, a fishing line may be attached to the quick-change spool using an arbor knot.

The spool cylinder or tape may be colored with a contrasting or bright color, such as red, green, blue, purple, yellow or orange. In this way, when the line runs low and the user will be notified that it is time to change spools before going fishing. It is also possible to provide colors or markings on the inside edge of the flange, and/or on the inside edge of the spool skirt which faces the fishing line, in order to provide information to the user about the amount of remaining line on the spool.

A particular advantage of the quick-change spool of the present application is that it may be made as a single monolithic piece, allowing for simple manufacture by injection molding or additive manufacturing. Additive manufacturing includes SLS and SLA. Preferably, the quick-change spool is made from a plastic which has sufficient flexibility and deformability so that it can pushed over the drag arbor to allow the spool retention detents to pass over the spool detent channel and snap into the spool retention recess. Examples include nylons, such as nylon-6, nylon-6,6 and nylon-12. This allows for low-cost production, as well as recyclability and low weight. Other plastics are possible, as long as they have similar hardness and flexibility. It is also possible to manufacture the quick-change spool from a metal such as aluminum, if the drag arbor is made of a plastic with sufficient flexibility and deformability. Similarly, both the modified drag knob and drag arbor may be made by injection molding or additive manufacturing as a monolithic piece, or alternative each may be made from other low cost and/or lightweight materials, including metals such as aluminum.

The quick-change spool may include a spool retention detent which is sufficiently thick, and/or curved slightly upward near the tip, such that it will break when the quick-change spool is pulled away from the drag arbor after attachment. This allows for a single use quick-change spool.

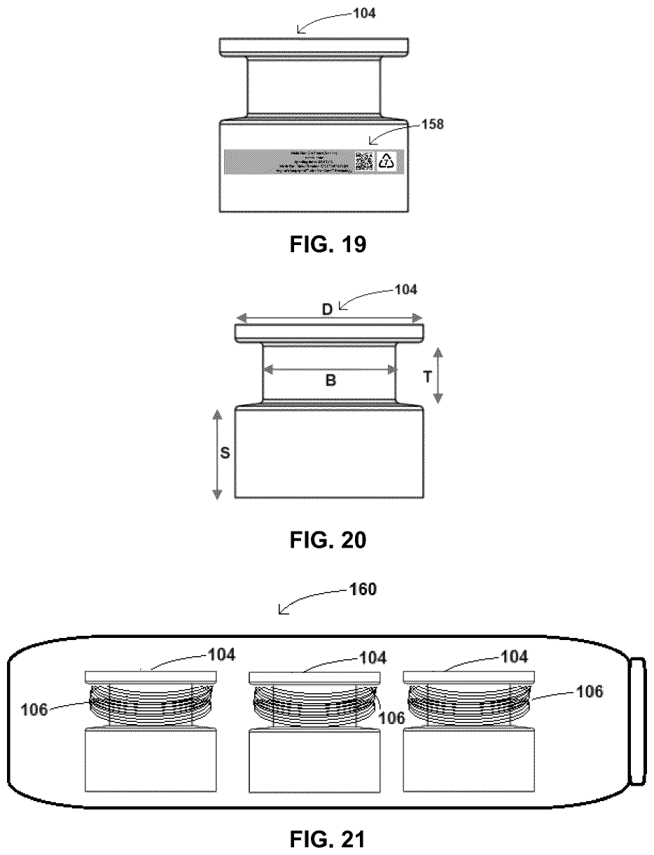

FIG. 19 illustrates a quick-change spool, 104, having a label, 158, on the spool skirt. The spool skirt is visible during use, and provides an ideal space to provide the user with information about the fishing line, including its type, strength and composition. Other information, such as the amount of line originally present on the quick-change spool, the manufacturer, date of manufacture or spooling of fishing line, reorder information (for example a web site address, UPC or QR code), or even advertisements (such as branding) could be placed onto the spool skirt. Such information may be embedded, embossed or etched into the surface of the spool skirt, during formation of the quick-change spool by injection molding or additive manufacturing. Alternatively, the information may be present on a label attached to the surface of the spool skirt. It would also be possible to simply write, for example with a stamp or by hand, the information onto the spool skirt.

The quick-change spool may be provided with fishing line already wound around the spool cylinder. Any type of fishing line may be used. A quick-change spool containing fishing line may contain monofilament line, such as nylon monofilament line, copolymer line containing fluorocarbons (often referred to as fluorocarbon line) or braided line. Preferably, the line is present in unit amounts, such as 50, 100 and 150 yards of line (or similarly 50, 100 and 150 meters of line). Preferably, only a single type of fishing line is present on a quick-change spool, although a backing line attached to a fishing line on the non-working end is also possible. For example, adding a short leader line (1-3 feet) of fluorocarbon or monofilament to braided line which has equal or lesser breaking strength than the main line is very common. Additionally, line class world records typically require a minimum of 15 meters of the leader line (for example, 15 meters of 4 lb fluorocarbon leader line could be tied to 100 meters of a 60 lb braided main line for a 4 lb line class world record). Preferably, the fishing line is wound around the spool cylinder to a distance of 1/16^{th} to ⅛^{th} of an inch (1.6 to 3.2 mm) away from the outside edge of the rim of the quick-change spool. As illustrated in FIG. 21, multiple quick-change spools, 104, each with the same or different fishing line, 106, may be present in a single package, 160. There may be 2, 3, 4, 5, 6, 7, 8, 9, 10 or even more spools containing fishing line in a single package. Within a single package the spools may all contain the same type and amount of fishing line. Alternatively, within a single package the spools may contain 2, 3, 4 or 5 different types of fishing line. For example, a single package may contain spools having 2 or 3 selected from braided fishing line, fluorocarbon fishing line and monofilament fishing line.

FIG. 20 illustrates a quick-change spool, 104, with various dimensions labelled in the figure, include the spool diameter, D, the spool cylinder diameter, B, the spool cylinder length, T, and the spool skirt length, S. The spool skirt length is preferably 0.5 cm (5 mm) to 7.5 cm (75 mm), including 10, 15, 20, 21, 22, 23, 24, 25, 26, 27, 28, 29, 30, 35, 40, 45, 50, 55, 60, 65 and 70 mm, and all ranges there between. The spool cylinder diameter, B, may be sized such that 100%, 75%, 50% or 25% of the conventional spool capacity of a specific fishing line, or fishing line type, will fit. “Fit” means that the fishing line, when wound around the spool cylinder, is present at a distance of 1/16^{th} to ⅛^{th} of an inch (1.6 to 3.2 mm) away from the outside edge of the rim of the quick-change spool (that is, the outer edge of the flange 110). This will result in the fishing line being at the sweet spot for optimal casting and use. “Conventional spool capacity” refers to the amount of fishing line able to fit on the conventional spools which was provided with the fishing reel from the manufacturer, for example 100, 150, 200 and 250 yards (or 50, 100, 150, 200 and 250 meters) based on line diameter. This avoids wasting line due to the mis-match between the amount of line provided in a retail fishing line package and the amount of line held on a conventional spool. Optimal spool cylinder diameters may be calculated as follows (see, for example, www.quabbin.com/tech-briefs/method-calculate-capacity-reel-or-spool) (using measurements in inches):

$$Spool Factor = ( H + B ) \times ( H ) \times ( T ) \times ( 0.262 )$$

Using the Spool Factor equation and the fishing line diameter, it is possible to calculate the approximate maximum line length in feet that will fit on that spool (where H+U=½(D−B), and U=unused portion of flange, and H=used portion of flange). Simply divide the Spool Factor by the diameter of the line in inches squared. Length of fishing line=Spool Factor/(Line Diameter)×2. Some examples are provided in Tables 1 and 2.

TABLE 1
(where T = 1 inch, D = 2 inches, and U = 0.125 inches; 14 lb. line)

| | | | Spool cylinder |
|---|---|---|---|
| | Line diameter | Line length | diameter required |
| Line type | (inches) | (yards) | (B) (inches) |
| Monofilament | 0.014 | 100 | 1.470 |
| Fluorocarbon | 0.013 | 100 | 1.515 |
| Braid | 0.009 | 100 | 1.640 |
| Monofilament | 0.014 | 150 | 1.310 |
| Fluorocarbon | 0.013 | 150 | 1.380 |
| Braid | 0.009 | 150 | 1.584 |

TABLE 2
(where T = 1 inch, D = 2 inches, and U = 0.125 inches)

| | Line | Test | Line | Spool cylinder |
|---|---|---|---|---|
| | diameter | of line | length | diameter required |
| Line type | (inches) | (pounds) | (yards) | (B) (inches) |
| Monofilament | 0.008 | 4 | 150 | 1.620 |
| Monofilament | 0.010 | 8 | 150 | 1.540 |
| Monofilament | 0.014 | 14 | 150 | 1.310 |

### EXAMPLE

### Example 1: Quick-Change Spool Spinning Reel

A quick-change spool spinning reel of the present application was prepared from a commercially available front drag spinning reel (Diawa Tatula MQLT2500D-XH), by replacing the drag knob and the spool of the commercial spinning reel with a modified drag knob, quick-change spool and drag arbor of the present application, as shown in FIG. 7-15. More specifically, the drag arbor was prepared by computerized numerical control (CNC) machining of aircraft grade aluminum round stock, which was then hard anodized. The drag disc assembly mechanism from the commercial front drag spinning reel was used with the drag arbor. The modified drag knob was prepared by selective laser sintering (SLS) 3-D printing through a commercial vendor, of nylon-12 (PA 2200 having a shore D hardness of 75). The drag knob assembly mechanism from commercial front drag spinning reel was used with the modified drag knob. The quick-change spools were also prepared by selective laser sintering (SLS) 3-D printing through a commercial vendor, of nylon-12 (PA 2200 having a shore D hardness of 75), having a skirt length of 2.2 cm (22 mm). Two different quick-change spools with different spool cylinder diameters (B), for a total of 18 quick-change spools, were prepared (12 of the first size (25% capacity), and 6 of the second size (50% capacity)); distance between flanges and outer diameter of all the spools matched those of the spools of the commercial front drag spinning reel.

3 different types of fishing line, one type on each spool, were attached to the quick-change spools using arbor knots and red electrical tape on the spool cylinder with a minimum of one rotation of tape. The remaining line was then wound around the spool cylinders. The types and amount of line used were Berkley Trilene XL Smooth Casting Line 1000 Yards-Clear-8 lb. Test (50% capacity spool, 0.25 mm diameter line, 100 yards per spool); Berkley Vanish Fluorocarbon Fishing Line 250 Yards-Clear-8 lb. (50% capacity spool 0.25 mm diameter line, 100 yards per spool); and Sufix 832 Advanced Superline Braid Fishing Line 300-Yard Spool-Low-Vis Green-8 lb. (25% capacity spool, 0.18 mm diameter, 100 yards per spool). A commercial line counter was used to ensure accurate line loading. Labels were applied to the skirts of the quick-change spools, identifying the fishing line type and line vendor present on each spool. The working end of each line type was contained within the sweet spot as designed.

The front drag spinning reels were then assembled using the parts prepared above. The parts were used as received, without modification. The spinning reels of the present application so prepared operated well with the remaining parts of commercial front drag spinning reel.

The quick-change spinning reels were tested in both North Carolina and Michigan with a total of 6 recreational anglers, each having at least several years of experience, for freshwater stream and lake fishing. The recreational anglers were provided a 5-minute tutorial on how to rapidly change spools, and were able to easily handle changing on their own. All 18 quick-change spools were tested. Changing spools was very straight forward and easy. Performance was identical to the commercial front drag spinning reels, except spools were rapidly interchangeable, contained less line and were comprised entirely of plastic materials that could be recycled or changed without having to unspool the line. The types of fish caught included walleye, small mouth bass, and largemouth bass.

### REFERENCES

“Welcome to Mel's 2019 Fishing Line Diameter page” (2019), available at www.melsplace.com/String/string.htm.

Reynolds, M., et al. “How to Spool a Spinning Reel” wikiHow (Sep. 15, 2015) available at www.wikihow.com/Spool-a-Spinning-Reel.

Robins, P. “How to Spool a Spinning Reel” Outdoor Life (May 22, 2023) available at www.outdoorlife.com/gear/how-to-spool-a-spinning-reel/.

Hanson, D. “How to Spool a Spinning Reel with Braided Line” Recreational Boating & Fishing Foundation (Feb. 2, 2022) available at www.takemefishing.org/blog/february-2022/how-to-spool-a-spinning-reel-with-braided-line/.

U.S. Pat. No. 9,480,246

U.S. Pat. Pub. No. 2009/0250542

U.S. Pat. No. 5,120,003

U.S. Pat. No. 6,712,300

U.S. Pat. No. 3,693,901

Material data sheet for PA2200, EOS GmbH-Electro Optical Systems, Robert-Stirling-Ring 1, D-82152 Krailling, München, Germany (2009).

1. A quick-change spool, comprising:
an exterior, including
(i) a spool flange, at a top end of the quick-change spool,
(ii) a spool skirt, at a bottom end of the quick-change spool, and
(iii) a spool cylinder, between the spool flange and the spool skirt, an interior, including
(iv) at least one spool alignment key, on a spool cylinder interior surface,
(v) at least one spool torque transfer key, on a spool skirt interior surface, and
(vi) at least one spool retention detent, on the spool skirt interior surface.

2. The quick-change spool of claim 1, further comprising:
fishing line, wound onto the spool cylinder.

3-5. (canceled)

6. The quick-change spool of claim 1, comprising:
a plurality of spool alignment keys, on the spool cylinder interior surface,
a plurality of spool torque transfer keys, on the spool skirt interior surface, and
a plurality of spool retention detents, on the spool skirt interior surface.

7. (canceled)

8. (canceled)

9. The quick-change spool of claim 2, having a label, on the spool skirt, wherein the label includes text which identifies the fishing line.

10. A quick-change spool system, comprising:
a quick-change spool, and
a drag arbor,
wherein the quick-change spool and the drag arbor are configured to:
(a) releasably attached together, through interaction between a spool retention detent and a spool retention recess, and
(b) transfer torque between each other when attached together, through interaction between a spool torque transfer key and a spool torque transfer slot, and
the quick-change spool comprises
(i) a spool flange, at a top end of the quick-change spool,
(ii) a spool skirt, at a bottom end of the quick-change spool, and
(iii) a spool cylinder, between the spool flange and the spool skirt.

11. The quick-change spool system of claim 10, wherein the quick-change spool includes an interior, the interior comprising:
(iv) the spool torque transfer key, on a spool skirt interior surface, and
(v) the spool retention detent, on the spool skirt interior surface, and the drag arbor comprises:
(vi) the spool retention recess, at a bottom end of the drag arbor, and
(vii) the spool torque transfer slot, between a top end and the bottom end of the drag arbor.

12. The quick-change spool system of claim 10, wherein the quick-change spool and the drag arbor are further configured to align during attaching, through interaction between a spool alignment key and a spool alignment key channel.

13. The quick-change spool system of claim 12, wherein
the quick-change spool further comprises (viii) the spool alignment key, on a spool cylinder interior surface, and
the drag arbor further comprises (ix) the spool alignment key channel, on the top end of the drag arbor.

14. The quick-change spool system of claim 10, further comprising a spool detent channel, configured to guide the spool retention detent to the spool retention recess.

15. The quick-change spool system of claim 13, wherein the drag arbor further comprises (x) a spool detent channel, configured to guide the spool retention detent to the spool retention recess.

16. (canceled)

17. (canceled)

18. The quick-change spool system of claim 10, further comprising a drag knob, wherein the drag knob and the quick-change spool are sized to allow the drag knob to pass through an interior of the spool cylinder.

19-21. (canceled)

22. A quick-change spool, comprising:
(i) a spool flange, at a top end of the quick-change spool,
(ii) a spool skirt, at a bottom end of the quick-change spool, and
(iii) a spool cylinder, between the spool flange and the spool skirt,
wherein the quick-change spool is monolithic and consists of plastic.

23. A ready-to-use quick-change spool, comprising:
the quick-change spool of claim 22, and
fishing line, wound onto the spool cylinder.

24. The ready-to-use quick-change spool of claim 23, wherein an end of the fishing line which is not attached to the quick-change spool is located at 1/16^{th} to ⅛^{th} of an inch or 1.6 to 3.2 mm, away from the outside edge of the spool flange.

25. The ready-to-use quick-change spool of claim 23, further comprising a label on the spool skirt, which identifies the fishing line.

26. A set of ready-to-use quick-change spools, comprising:
a package, and
a plurality of ready-to-use quick-change spools of claim 25, contained in the package.

27. (canceled)

28. (canceled)

29. The set of claim 26, wherein:
a first ready-to-use quick-change spool of the plurality of the ready-to-use quick-change spools includes a first type of the fishing line and a first diameter of the spool cylinder,
a second ready-to-use quick-change spool of the plurality of the ready-to-use quick-change spools includes a second type of fishing line and a second diameter of the spool cylinder,
the first type of fishing line is different from the second type of fishing line, and the first diameter of the spool cylinder is different from the second diameter of the spool cylinder.

30. (canceled)

31. (canceled)

32. A method of making the quick-change spool of claim 1, comprising injection molding or forming with additive manufacturing, wherein the quick-change spool is monolithic and consists of plastic.

33. (canceled)

34. (canceled)

35. A method of using the quick-change spool system of claim 10, comprising exchanging the quick-change spool for a different quick-change spool.

36-40. (canceled)
